(19) United States
(12) Patent Application Publication
(10) Pub. No.: US 2007/0283602 A1
(43) Pub. Date: Dec. 13, 2007

(54) Method for forming a greeting card assembly, and the greetting card assembly formed thereby

(76) Inventor: Peter Connors, Portsmouth, NH (US)

Correspondence Address: JONES DAY, 555 SOUTH FLOWER STREET FIFTIETH FLOOR, LOS ANGELES, CA, 90071, US

(21) Appl. No.: 11/437,354

(22) Filed: May 19, 2006

(51) Int. Cl. G09F 1/00

(52) U.S. Cl. 40/124.07

(57) ABSTRACT

A method for creating a standard type greeting card constructed of standard paper stock which in addition to delivering written text and artwork to the recipient, can also deliver a physical hug to the recipient as the surrogate of the sender, the process comprising the steps of selecting a paper stock that can accept and retain written text and/or artwork and which will, when held in a coiled position for a length of time, assume a coil-biased condition that will gently resist unraveling, and when initially unraveled, will bias back towards the coiled condition; adding printing and artwork as desired to the paper stock while that stock is in its flat condition; cutting the stock into the overall desired shape of the greeting card; rolling the now cut paper stock greeting card into a scroll-type configuration; and inserting the scrolled card into a tubular container that can also be used as the shipping container for the card, such that the container becomes part of the manufacturing process by which the desired resultant greeting card is produced. The resultant greeting card thus conveys not only the sentiment contained in the words and artwork on the paper card, but also a physical hug from the sender.

### BACKGROUND OF THE INVENTION

This invention relates generally to a type of greeting card assembly, and to the method by which the item is formed. More specifically, this invention relates primarily to a simple means by which standard stock paper can be used to create a type of greeting card that can simulate the delivery by the sender of a hug to the recipient.

The custom of sending one's “greetings” to another is said to trace back to the ancient Chinese whose New Year's celebrations included the sending of written goodwill messages to friends and loved ones. Evidence has also been found that the ancient Egyptians used papyrus scrolls to send one another commemorative messages. In Europe, the Germans are believed in the early 1400's to have exchanged hand-made and hand-delivered goodwill messages for New Years and Valentine's Day on elaborate, paper-based products that were printed from hand-engraved woodcuts dies.

In the mid-1800's the advent of printing machines and of the postage stamp led to the greeting card becoming an inexpensive form of interpersonal communication, although still mainly for New Years and Valentines. Indeed, the very first Christmas card is believed to have been developed in London in 1843. It was not, however, until the lithographic process was developed that the greeting card business truly flourished. In the United States, this is believed to have been innovated by a German immigrant, Louis Prang, who in 1856 settled in the Boston area, and by 1875 had introduced the first complete line of Christmas cards to the American public.

Since then, the greeting card has become ubiquitous, and is used to commemorate just about every holiday and societal or cultural event from birth to burial, or to convey just about every possible human emotion, from affection to affectation, from humor to hubris, and from sorrow to sympathy. The total market for greeting card in the United States is huge (estimated to be approximately $7.5 billion in 2004, with an annual growth rate of approximately 8.7%). With the expansion of the reach, speed and content on the Internet, however, the traditional paper-based greeting card is being challenged in the market by the virtual greeting card or e-cards that are now very prevalent. Accordingly, the publishers of paper greeting cards are seeking ways to further differentiate themselves from the greeting card type products that are available in the Internet, as the Internet has in some ways fostered the quick and easy interaction between people.

Another interesting form of human interaction, however, is the physical “hug.” (See, e.g., Hug Therapy, Keating, 1983). Indeed, the human hug is such an integral part of our culture that phrases like “group hug” and “you need a hug” have become part of the American lexicon. Some researchers report positive health benefits from a regular hug regimen for people of all ages, and that new-born babies can suffer and perish if deprived of human touch, or that newborn twin babies benefit from being held in the same crib where they can touch one another. (See, e.g., www.eqi.org/ht.htm). Others believe that a hug from the right person can even provide a spiritual awakening. (See, e.g. The Power of a Hug, Sep. 25, 2003, as reported at www.rediff.com/news/2003/sep/24amma3.htm). Even corporate America has seized upon the positive connotations of the touch implicit in the human hug for marketing purposes—for one example, AT&T introduced the “reach out and touch someone” marketing slogan and jingle in 1981 that became so successful that it too has also become part of the American lexicon.

For these reasons, combining the written form of expressing one's feelings with a “hug” is desired, and is not new. Indeed, the inclusion of “XOXOXO” at the end of a letter to send “hugs and kisses” has long been in common practice. And a search on the Internet using the search terms “hug” and “cards” turns up a myriad of traditional greeting cards that seek to say (in words) they are sending the recipient a “hug” (as in “Here's a bear hug for you from me”).

In addition, novelty items that attempt to simulate a human hug are known. For example, in U.S. Pat. No. 4,724,548, a HUGGING NOVELTY DEVICE is disclosed in which a coiled flexible strip (constructed of plastic or similar material) is designed to be unfolded by the recipient and placed around their waist to visually represent a hug. The plastic-like material is predisposed or pre-stressed so as to form a coil when free from external forces (that is the recipient's pulling the ends of it apart). The ends of the flexible strip are fitted with notches to which “hands” or other appendages can be attached. U.S. Design Pat. Nos. D460,481 and Des. 279,727 show respectively a NOVELTY WRAP and a GREETING CARD that are capable of delivering a “hug.”

These prior art devices, however, are difficult and costly to manufacture, cumbersome, and in the case of the devices shown in the '481 and '727 patents, difficult to package for effective shipping. Display and handling of these prior art devices at the retail store is not optimal, either. Further, none of these prior art devices disclose anything that resembles or can effectively compete with a traditional paper greeting card.

As in most commercial endeavors, the ease and price at which a product can be made, marketed, distributed, displayed and delivered are key components of the overall design of the product. Greeting cards are no exception. This is the reason why most greeting cards are made of paper, why most are of a compact size and shape, and why most of them sell at prices ranging between $1 and $3. These products are intended not to be a gift that is used by the recipient, but to convey a sentiment that the sender wishes to communicate, and to do so in a way that the products can be easily and inexpensively manufactured, handled, displayed in large numbers, and shipped. The prior art devices do not meet those design criteria.

Therefore, there exists a need in the art for an improved greeting card design that can not only convey the written sentiment of traditional greeting cards, but can also physically deliver a hug to the recipient, and do so in a design that is relatively inexpensive to manufacture, market, display, distribute and deliver so that its selling price can be competitive with traditional greeting cards, and will be a viable and desirable alternative to the virtual greeting card products now available on the Internet.

### SUMMARY OF THE INVENTION

This invention provides a method for producing such a greeting card, and the greeting card produced by that method. In short summary, standard paper stock is utilized to create the card portion of the overall invention, the desired art work and written material are added, and the paper stock is cut into the desired outline, all of this occurring while the paper is in its natural flat condition, and then the card portion is rolled up into a scroll-like condition and inserted into a small tubular container that also comprises the shipping container for the card. Once received and removed by the intended recipient, the paper stock card portion will have taken on the relatively gentle coil-biasing produced by its time in the small tube, such that the recipient will not only receive the sentiment conveyed by the written text and artwork, but will also receive a physical hug from the card as a surrogate for the sender.

The card portion can be imprinted with any of innumerable type of artwork and text, and can be shipped to the retail stores in its flat condition and separately from the shipping tube. This will allow for ease of handling of the two components and will also allow the retail stores to more easily display them in a flat condition if so desired. Once purchased, the purchaser/sender can inscribe whatever additional handwritten notes that he or she desires on the card portion while it is still in its flat condition (and thus easier to handle and write upon), and then scroll and insert it into the shipping tube. Within a very short period of time, the inserted scroll will adapt to its new condition and will resist unraveling completely even when removed from the tube.

If the recipient desires to keep the card for future reference or for posterity, the card can be easily returned to a natural flat condition for storage and display.

The greeting card produced by this method can not only compete with the traditional paper greeting card, it provides something that the virtual or e-card that is available on the Internet and sent via the Internet cannot provide—a physical surrogate hug from the sender.

### DESCRIPTION OF THE FIGURES

FIG. 1 is a perspective view of the preferred embodiment of this invention showing its main components comprising the paper-stock card that is prepared, printed and cut in its natural flat state, and the small tubular container in which it is shipped, which shipping is sufficient to impart the coiled configuration to the paper-stock card.

FIG. 2 is top planar view of the preferred embodiment of this invention showing the paper stock of the greeting card in its natural, flat state, and in an overall shape that is one of the preferred embodiments, before it is printed, coiled, and placed in the shipment tube.

### DESCRIPTION OF THE PREFERRED EMBODIMENTS

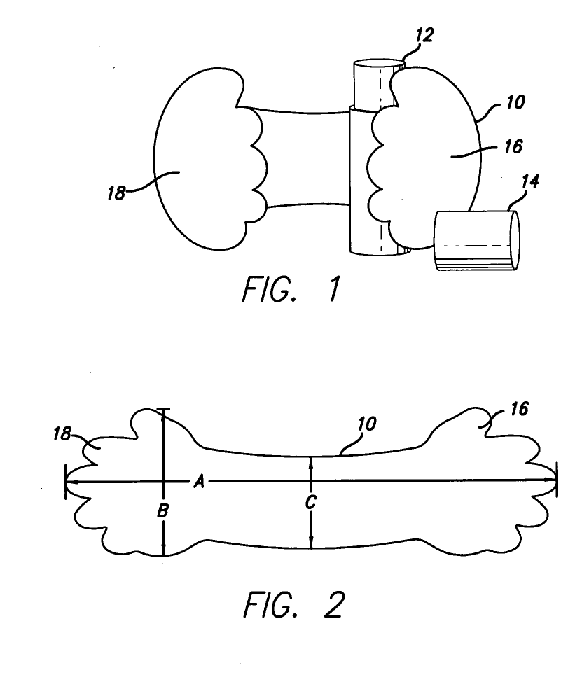

Looking at FIG. 1, the three components of the product of this invention are shown—the paper stock card 10, the shipping tube 12 that is closed on one end and open on the other, and the cap 14 this fits over and closes the open end of the tube 12 after the paper stock card 10 is coiled and inserted.

The paper stock card portion 10 is shown in a flat, planar view in FIG. 2, and is shown there to be of unitary construction. The preferred dimension A is 17 inches, and the preferred dimension B is 5.25 inches. The preferred dimension C is 3.25 inches. The preferred paper stock is 80# cover with a felt finish.

The preferred dimensions of the shipping tube 12 are 1.5 inches in diameter and 6.5 inches in length.

The outline of the paper stock portion or the card 10 is a preferred shape. As noted it is in the general outline of a pair of hands 16 and 18. The overall size of the card portion 10 is sufficiently large so that any number of different themes (artwork and text) can be interchangeably added to the “front” and “back” of the card portion 10. For example, artwork depicting the upper torso of a grandfatherly person with outstretched arms could be created, and could be used by a grandfather to send a “hug” to his granddaughter on her birthday. Or, artwork depicting the upper torso and outstretched arms of a doctor or a nurse could be used to send a “get well soon” hug to an ill or ailing person. Or, artwork depicting the upper torso and outstretched arms of a bear could be used to send a “bear hug” to someone. The possibilities are literally limitless, and all can be included on the same overall size and shape of the card portion 10.

The process by which this card is created is quite simple and inexpensive. The preferred paper stock is cut into the overall size and shape as depicted in FIG. 2. The desired artwork and any desired text is imprinted on the card portion 10 by any suitable means—lithography, photo, photocopy, laser engraving, traditional printing, for examples. It should be noted that these steps could easily be reversed, with the artwork and text being imprinted on the paper stock first, and the outline cut second. Once the artwork and text have been applied and the card portion 10 cut into the desired shape, the card portion 10 is rolled into a sufficiently tight scroll so that it can be easily inserted into the tube 12, and it then is inserted.

Prior to insertion of the card portion 10 into the tube 12, a simple paper ring having a diameter less than the interior diameter of the tube 12 can be fitted around the now-scrolled card portion 10 to hold it in place, and to facilitate removal of the card portion 10 from the tube 12.

Although preferred embodiments have been shown and described, the disclosed invention and the protection afforded by this patent are not limited thereto, but are of the full scope of the following claims, and equivalents thereto.

1. A method for creating a greeting card assembly that can also deliver a surrogate hug from the sender, the method comprising the steps of:
a) selecting a substantially flat paper stock that can accept and retain written text and/or artwork and which will, when held in a coiled position for a length of time, assume a coil-biased condition that when physically unraveled, will gently seek to return to its coiled condition, but which can be returned to a substantially flat condition for storage or display;
b) adding printing and artwork as desired to the paper stock while that stock is in its flat condition;
c) cutting the stock into the overall desired shape of the greeting card;
d) rolling the now cut paper stock greeting card into a scroll-type configuration; and
e) inserting the scrolled card into a tubular container which will restrain the greeting card in its scroll-like configuration, and that can also be used as the shipping container for the card.

2. The invention of claim 1 wherein said paper stock is 80# cover with a felt finish.

3. The invention of claim 1 including the further step of installing a restraining ring having an exterior diameter which is less than the interior diameter of same tubular container.

4. The product produced by the process of claim 1.

5. A greeting card assembly that comprises:
a) a paper card portion upon which artwork and text can be imprinted, which paper is in a natural flat condition, and which can be cut into a predetermined size and shape;
b) said paper card portion being constructed of paper having a sufficient weight that it can be easily rolled up into a scroll-like condition, and which when released from the condition after a length of time will have assumed a loose scroll-condition; and
c) a tube of sufficient size and shape such that the rolled up paper card portion can be easily and fully inserted therein; said tube having sufficient strength and weight characteristics such that it can be used as the shipping container for shipment through first class mail at a reasonable price.
